(19) United States
(12) Patent Application Publication
(10) Pub. No.: US 2026/0035975 A1
(43) Pub. Date: Feb. 5, 2026

(54) GUIDE SYSTEM FOR MOVABLY SUPPORTING AT LEAST ONE COVER ELEMENT

(71) Applicant: Julius Blum GmbH, Hoechst (AT)

(72) Inventors: Florian FISCHER, Hoechst (AT); Gerhard KLEINSASSER, Dornbirn (AT); Hermann HAEMMERLE, Lustenau (AT); Matthias REISSIG, Lindau (AT); Alexander Simon FLOGAUS, Eriskirch (DE)

(21) Appl. No.: 19/353,198

(22) Filed: Oct. 8, 2025

Related U.S. Application Data
(63) Continuation of application No. PCT/AT2024/060129, filed on Apr. 10, 2024.

(30) Foreign Application Priority Data
Apr. 12, 2023 (AT) A 50265/2023

(51) Int. Cl. E05D 15/10

(52) U.S. Cl. CPC E05D 15/1015; E05D 2015/1031; E05Y 2201/654; E05Y 2201/672; E05Y 2900/148

(57) ABSTRACT

A guide system is provided for movably supporting a cover element for covering an opening in a stationary structure. The guide system includes a first guide rail and a first guide body movably arranged thereon, a second guide rail and a second guide body movably arranged thereon, and a compensation device for compensating for a tilting moment of a cover element. The cover element can be moved by the guide system between a first position and a second position, and the compensation device has a cable connecting the first guide body and the second guide body together. A deflecting device allows the cable to be guided orthogonally to the longitudinal extension of the first guide rail and/or the second guide rail at least in some regions, preferably in a region between the first guide rail and the second guide rail.

The present application is a continuation of International Application PCT/AT2024/060129 filed on Apr. 10, 2024. Thus, all of the subject matter of International Application PCT/AT2024/060129 is incorporated herein by reference.

### BACKGROUND OF THE INVENTION

The invention relates to a guide system for movably supporting at least one cover element for covering an opening in a stationary structure, comprising:
a first guide rail and a first guide body movably arranged thereon,
a second guide rail and a second guide body movably arranged thereon, and
a compensation device for compensating for a tilting moment of a cover element. The cover element can be moved by the guide system between a first position, preferably a closed or intermediate position, and a second position, preferably an open position, and an arrangement having at least one such guide system.

Such guidance systems are already known from the state of the art and are used for guiding (furniture) doors or folding-sliding doors, for example. A compensation device is necessary in guide systems in which one end of the cover element floats freely (in other words, is not guided) when the cover element is in the open state in order to prevent a tilting moment of the cover element and thus a lowering of the cover element.

In the current state of the art, pivoting lever mechanisms or cable pull devices are usually used for this purpose. Prior art compensation devices cannot be used in the case of conventional sliding doors or, in particular, sliding windows, in which the opening is in a closed or intermediate position immediately behind the cover element. Prior art compensation devices extend into a region of the opening when the cover element is in an open position in order to enable sufficient support of the cover element.

This would render a window or door unusable because the compensation device would at least partially block the window or door.

### SUMMARY OF THE INVENTION

It is the object of the invention to at least partially remedy the disadvantages described above and to provide a guide system which is improved compared to the prior art and an improved arrangement having such a guide system.

According to the invention, the compensation device has at least one cable, the at least one cable connecting the first guide body and the second guide body together, and a deflecting device is provided by which the at least one cable can be guided orthogonally to a longitudinal extension of the first guide rail and/or the second guide rail at least in some regions, preferably in a region between the first guide rail and the second guide rail.

This allows guiding a cable in such a way that an opening remains free in an open position. In other words, the cable essentially runs outside a region of the opening. At the same time, however, sufficient compensation for a tilting moment can still be guaranteed.

An arrangement according to the invention comprises a stationary structure, at least one opening formed therein, at least one cover element, and at least one guide system according to the invention, wherein the cover element can be moved by the guide system between a first position, preferably a closed or intermediate position, and a second position, preferably an open position.

The deflecting device may comprise at least three, preferably exactly three, deflection rollers.

Preferably, two of the at least three deflection rollers are arranged on or in the region of the first guide rail and another one of the at least three deflection rollers is arranged on or in the region of the second guide rail. This allows implementing a deflecting device in a simple and cost-effective manner.

Advantageously, two of the at least three rollers (preferably one roller in the region of the first and one roller in the region of the second guide rail) are used to guide the cable orthogonally and another of the at least three rollers (preferably the second roller in the region of the first guide rail) is used to deflect the cable onto a guide body.

Preferably, a shortening mechanism can be provided, via which a length of the at least one cable can be adjusted between a first and a second position depending on a position of the cover element.

The further a cover element is moved from a first position to a second position, i.e., the further a cover element is opened, the higher the occurring tilting moment becomes, since the acting lever extends. This is not taken into account in the prior art, which means that a tilting moment is essentially only compensated for in one position of the cover element. In all other positions, there is either over- or under-compensation.

This problem can be solved with a shortening mechanism by changing the effective length of the cable via the shortening mechanism depending on the position of the cover element. In a closed or intermediate position of the cover element, the cable is therefore at its longest, while it is shortened as the opening increases to take the increasing tilting moment into account.

Conversely, the effective length of the cable is extended when moving from an open position to a closed or intermediate position via the shortening mechanism.

The tilting moment of the cover element can therefore always be compensated for accordingly. It is also conceivable to cause deliberate overcompensation to achieve a lifting of the cover element.

The shortening mechanism can be configured in the form of a tapered roller. This represents a simple way to implement a shortening mechanism. At least one cable can be wrapped around the tapered roller, for example.

It is also conceivable to provide a stepped roller, two rollers of different sizes that are connected to one another such that they can rotate, or a roller having a special contour.

Preferably, the shortening mechanism can also have at least one guide groove in which the at least one cable is guided.

Particularly preferably, the at least one guide groove can extend helically along a tapered partial length of the tapered roller. This ensures that at least one cable is guided safely and correctly on the tapered roller.

According to another exemplary embodiment of the invention, at least one cable tensioning device, preferably at least two cable tensioning devices, can be provided for tensioning the at least one cable. This allows a cable to be tensioned and adjusted accordingly, for example after the guide system has been installed, to ensure that the guide system functions properly.

The at least one cable tensioning device can have a tool holder, preferably in the form of a screw head drive, for actuating the cable tensioning device. This makes it easy to operate the cable tensioning device.

Advantageously, the at least one cable tensioning device can be arranged on or in the shortening mechanism. This allows to provide minimal installation space for the cable tensioning device.

However, it is also conceivable that the at least one cable tensioning device is arranged on one of the guide bodies.

Preferably, the cable tensioning device can have a cable drum onto which the at least one cable can be wound or from which it can be unwound. This represents a simple implementation of a cable tensioning device.

However, other embodiments of a cable tensioning device are also conceivable. For example, a thread pressed onto at least one end of the cable could be provided. The cable tension could then be adjusted using a nut arranged on this thread. In principle, any suitable type of cable tensioning device is conceivable.

The cable tensioning device can also have a locking device for locking the cable tensioning device. This prevents the cable tensioning device from being accidentally activated or from coming loose by itself.

In one exemplary embodiment, the locking device may comprise a locking mechanism and/or a locking pin. If both a locking mechanism and a locking pin are provided, a particularly secure locking of the cable tensioning device can be achieved.

Particularly preferably, the at least one cable can be formed from at least partial lengths. This makes installation and adjustment of a compensation device easier.

One of the at least two partial lengths can be rolled up onto the tapered roller during a movement of the cover element between a first and a second position, and the other of the at least two partial lengths can be rolled off the tapered roller.

In this exemplary embodiment, the cable is shortened because, due to the tapered shape of the roller, not as much cable is rolled off as rolled up.

Particularly preferably, at least one connecting device is provided for connecting the at least two partial lengths of the at least one cable, preferably wherein the connecting device is formed by the shortening mechanism and/or the at least one cable tensioning device.

In particular, if the connecting device is formed by the shortening mechanism and/or the at least one cable tensioning device, a compensation device is obtained which is easy to assemble and adjust and which is also designed to save space.

As for an arrangement according to the invention, the cover element can be substantially square, the guide system can have four hinges which are arranged in the first position in the region of the four corners of the cover element, preferably wherein two hinges are arranged vertically spaced apart from one another on the stationary structure, and two hinges are arranged vertically spaced apart from one another on the cover element and are connected to the cover element in a motion-coupled manner.

On the one hand, the cover element can be guided via the hinges. On the other hand, the cover element can be transferred via the hinges from a closed position in which the cover element closes the opening into an intermediate position in which the cover element is arranged in front of the opening, but at an orthogonal spacing therefrom.

The at least one cable can also be arranged substantially, preferably completely, outside a region of the opening.

This leaves an opening free, allowing a window or door to remain fully usable.

### BRIEF DESCRIPTION OF THE DRAWINGS

Further details and advantages of the invention will be explained in more detail below with reference to the drawings, in which:

FIG. 1a is a schematic perspective view of an arrangement in a closed position,

FIG. 1b is a schematic perspective view of an arrangement in an intermediate position,

FIG. 1c is a schematic perspective view of an arrangement in an open position,

FIG. 2a is a schematic perspective view of a stationary structure,

FIG. 2b is a schematic perspective view of a guide system and a cover element,

FIG. 3a is a schematic sectional view of an arrangement in an intermediate position,

FIG. 3b is a schematic perspective view of an arrangement in a closed position,

FIG. 3c shows the detail A of FIG. 3b,

FIGS. 4a-f are schematic sectional views of various embodiments of a cover element,

FIG. 5a is a schematic perspective view of a guide system in a closed position,

FIG. 5b shows the detail A of FIG. 5a,

FIG. 5c is a schematic perspective view of a guide system in an intermediate position,

FIG. 5d shows the detail A of FIG. 5c,

FIG. 5e is a schematic perspective view of a guide system in an open position,

FIG. 5f shows the detail A of FIG. 5e,

FIG. 5g is a schematic perspective view of detail A of FIG. 5e from a different angle,

FIG. 6a is a schematic perspective view of a hinge for a guide system in a closed position,

FIG. 6b is a schematic perspective view of a hinge for a guide system in an intermediate position,

FIG. 6c is a schematic perspective view of a hinge for a guide system in an open position,

FIG. 6d is an exploded view of a hinge for a guide system,

FIG. 7a is a schematic perspective view of a compensation device, a guide body, and a cover element in a closed or intermediate position,

FIG. 7b is a schematic perspective view of a compensation device, a guide body, and a cover element in a half-open position,

FIG. 7c is a schematic perspective view of a compensation device, a guide body, and a cover element in an open position,

FIG. 8a is a schematic representation of a shortening mechanism in a closed or intermediate position,

FIG. 8b is a schematic representation of a shortening mechanism in a half-open position,

FIG. 8c is a schematic representation of a shortening mechanism in an open position,

FIG. 9 is an exploded view of a shortening mechanism,

FIG. 10a shows a first step for tensioning a cable with a cable tensioning device,

FIG. 10b shows a second step for tensioning a cable with a cable tensioning device,

FIG. 10c shows a third step for tensioning a cable with a cable tensioning device.

### DETAILED DESCRIPTION OF THE INVENTION

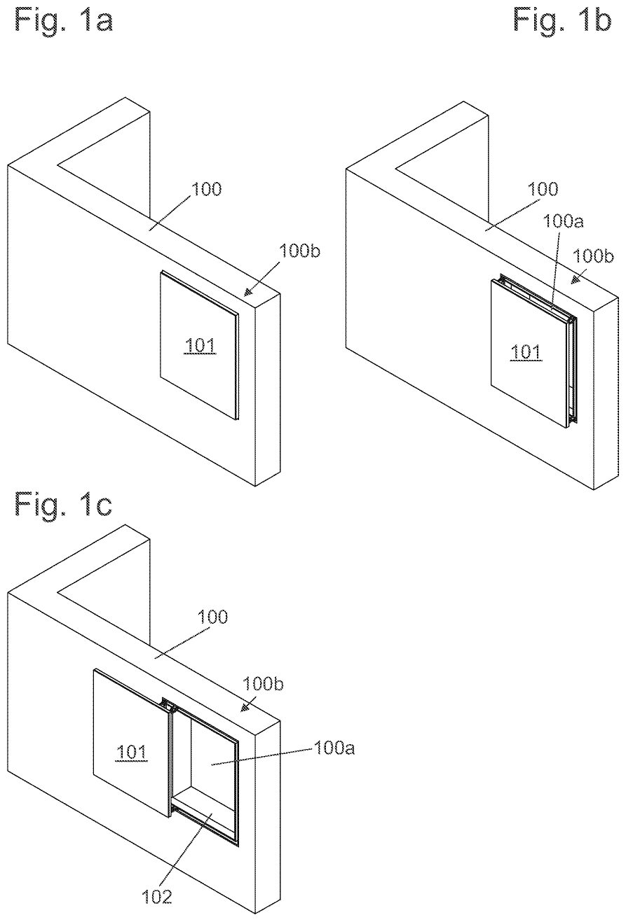

FIGS. 1a to 1c show three preferred positions of an arrangement, wherein the positioning of the arrangement in FIG. 1a corresponds to a closed position, in FIG. 1b to an intermediate position, and in FIG. 1c to an open position. In the closed position (FIG. 1a), the cover element 101, here in the form of a window, is completely closed, whereas in the intermediate position (FIG. 1b) it is orthogonally spaced from the opening 101a. In the open position, the cover element 101 is completely open and the opening 100a is accessible.

In this exemplary embodiment, the intermediate position corresponds to a first position and the open position to a second position. However, it is also conceivable that no intermediate position is provided, instead the cover element 101 can be transferred directly from a closed position to an open position. The closed position would then correspond to the first position.

The arrangement comprises an electric drive device 12, a cover element 101 in the form of a window, which can be displaced relative to a stationary structure 100, for closing an opening 100a of the stationary structure, and a guide system 1, with which the cover element 101 can be displaced relative to the stationary structure 100 to expose or cover the opening 100a.

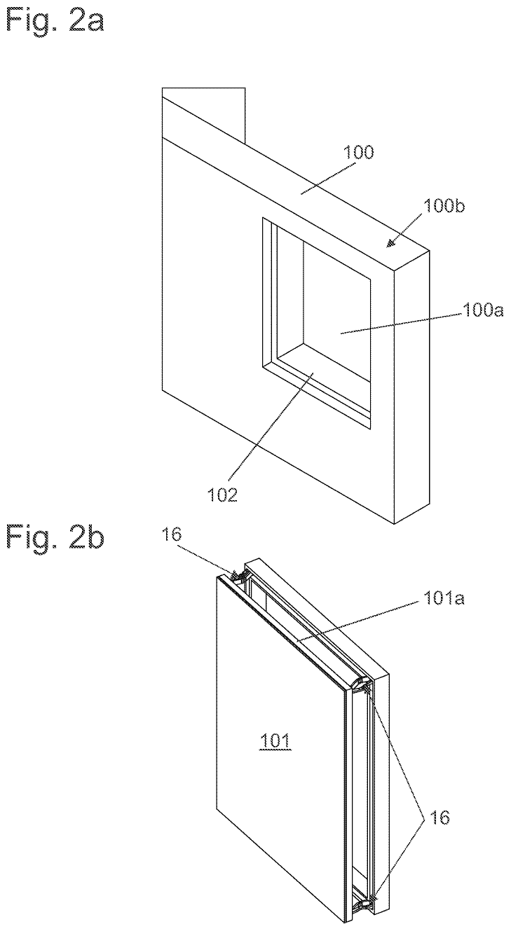

FIG. 2a shows a stationary structure 100 and FIG. 2b shows a guide system 1 and a cover element 101. The guide system 1 comprises a first guide rail 2 and a second guide rail 4 for the relative movement of the cover element 101 with respect to the stationary structure 100.

The first guide rail 2 and the second guide rail 4 are arranged in a component block 102 for connecting the stationary structure 100.

In addition, additional guide rails 13, 14 are integrated into a frame 101a of the cover element 101 and recessed therein.

The cover element 101 can be arranged substantially flush with the stationary structure in the closed position and arranged parallel to the stationary structure 100 in the intermediate position and in the open position.

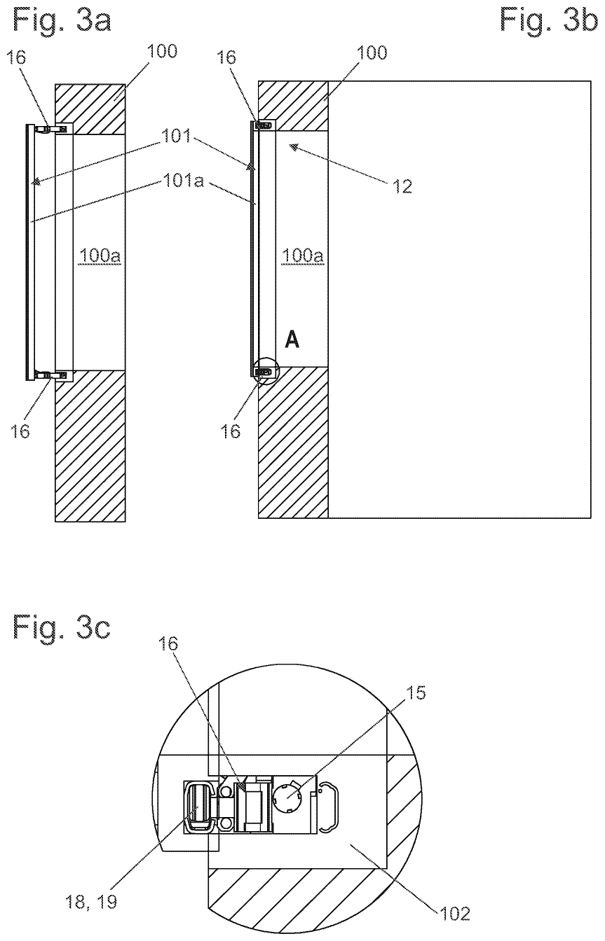

FIG. 3a shows a sectional view of the intermediate position and FIG. 3b shows a sectional view of the closed position of the cover element relative to the guide system.

FIG. 3c shows detail A of FIG. 3b. It is apparent that two movably mounted and horizontally oriented synchronization rods 15 are provided.

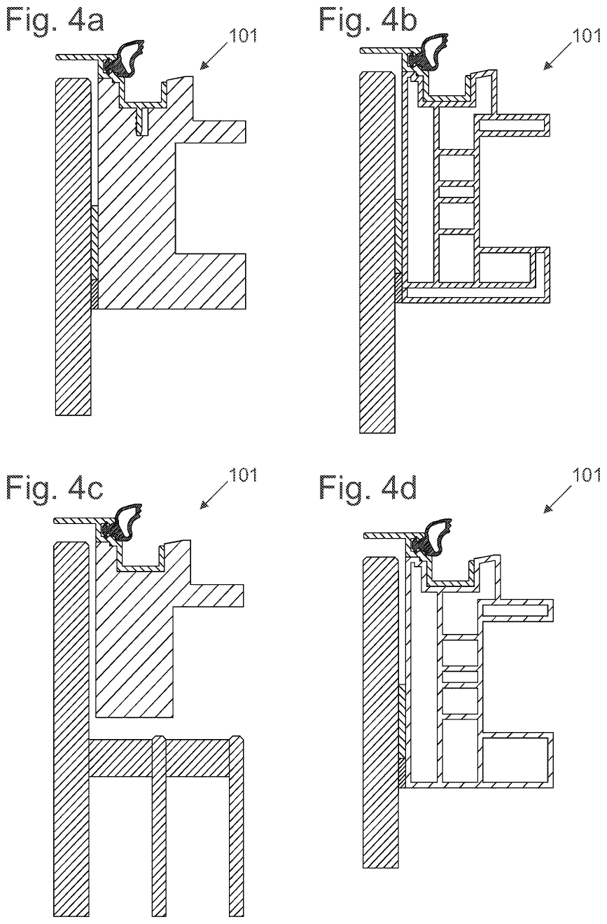

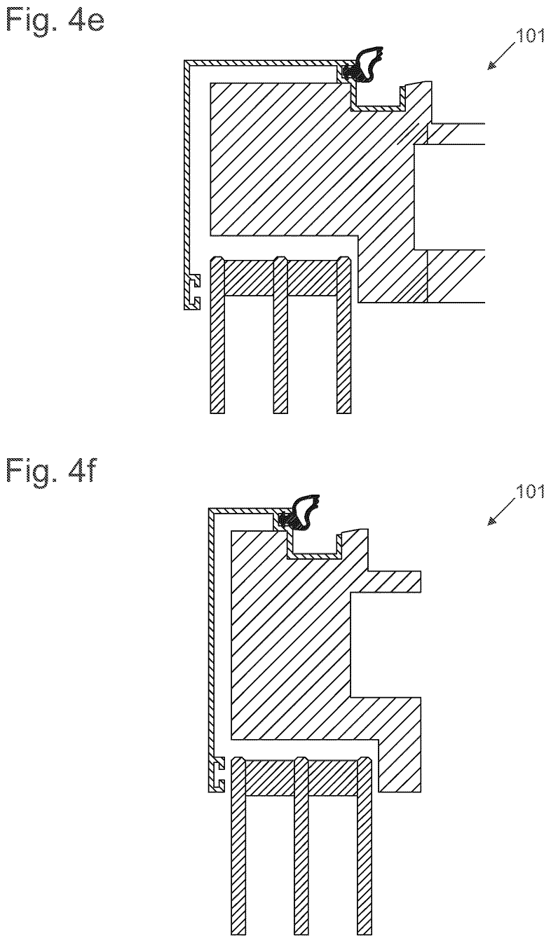

FIGS. 4a to 4f show possible constructions of the cover element 101 in the form of a window, wherein other designs or material combinations are also possible in order to reduce thermal conductivity and/or thermal bridges.

In FIG. 4a, a design with a vacuum-insulated glass with a wooden frame connected to an aluminum profile is selected. In FIG. 4b, a vacuum-insulated glass unit is arranged on an aluminum profile without wood-like materials. In FIG. 4c, the cover element 101 comprises a stepped rebate glass in combination with wood and aluminum. In FIG. 4d, a vacuum-insulated glass unit is connected to a plastic profile and an aluminum profile. In FIG. 4e and FIG. 4f, a multi-pane insulated glass unit is arranged on wood and aluminum with different geometries for connection to a guide system 1.

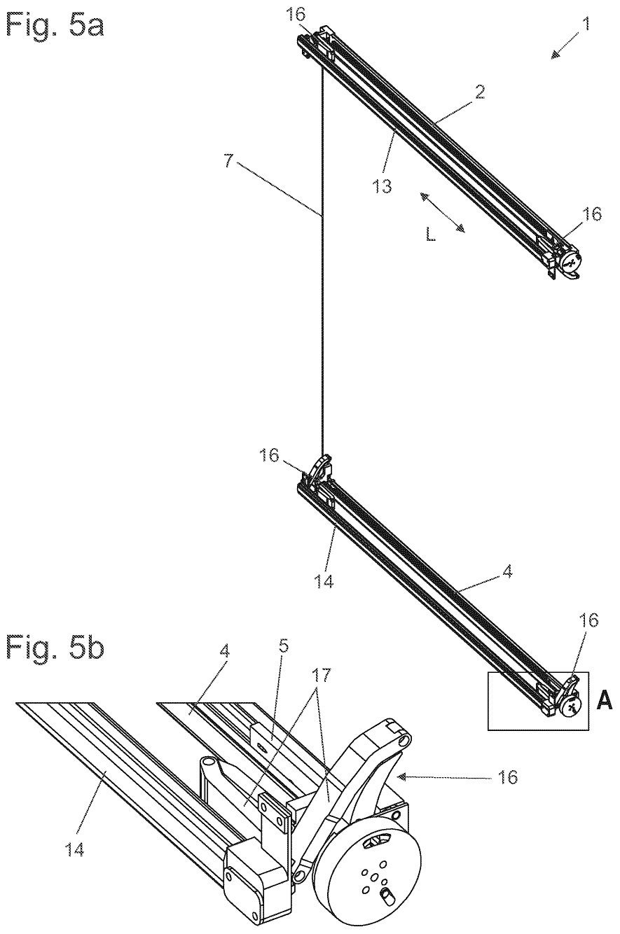

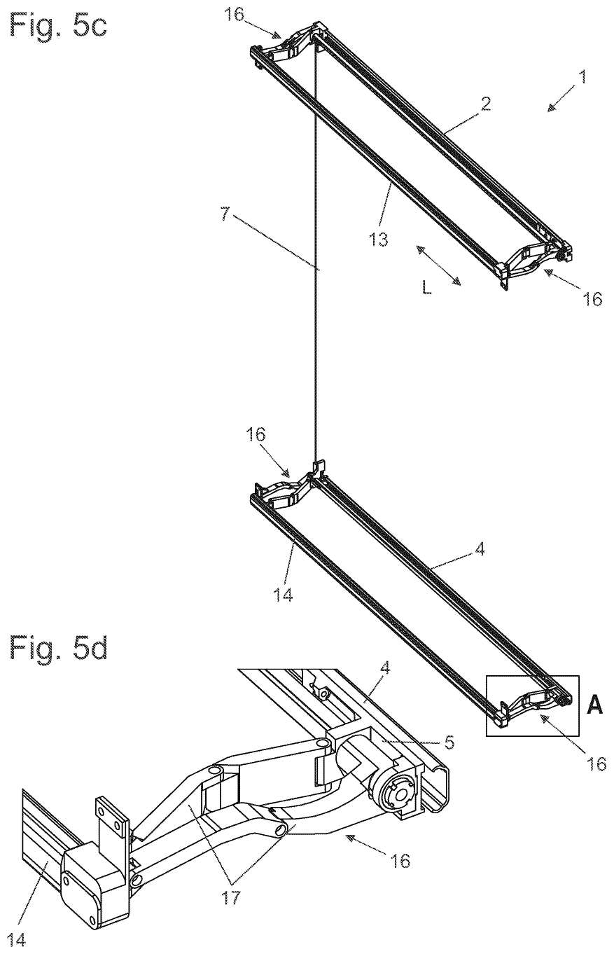

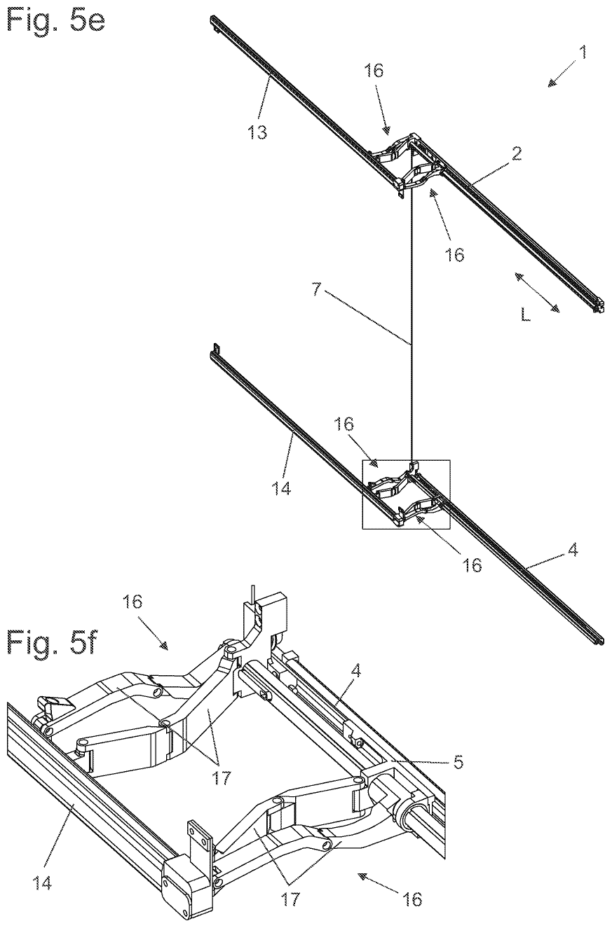

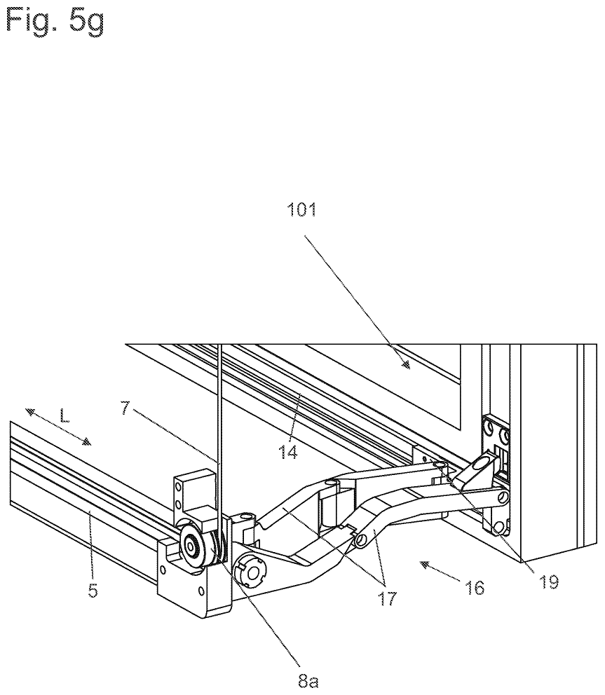

FIG. 5a shows the guide system 1 in isolation in the closed position, wherein the synchronization rods 15 are movably mounted in a stationary bearing of hinges 16, although this is not absolutely necessary.

The drive device(s) 12 interact with four hinges 16, each comprising two toggle levers 17.

FIG. 5b shows detail A of FIG. 5a.

FIG. 5c shows the guide system 1 in an intermediate position, while FIG. 5e shows the guide system 1 in the fully open position of the cover element 101. FIG. 5d shows detail A of FIG. 5c and FIG. 5f shows detail A of FIG. 5e.

FIG. 5e shows, in comparison to FIG. 5c, that two hinges 16 are arranged stationary on the guide rails 2, 4 and two hinges 16 are arranged stationary on the additional guide rails 13, 14, such that the additional guide rails 13, 14 are movable relative to the guide rails 2, 4, wherein two hinges 16 are displaceable relative to two hinges 16.

FIG. 5g shows a schematic perspective view of detail A of FIG. 5e from a different angle, wherein the guide rail 14 is movable parallel to the guide rail 4.

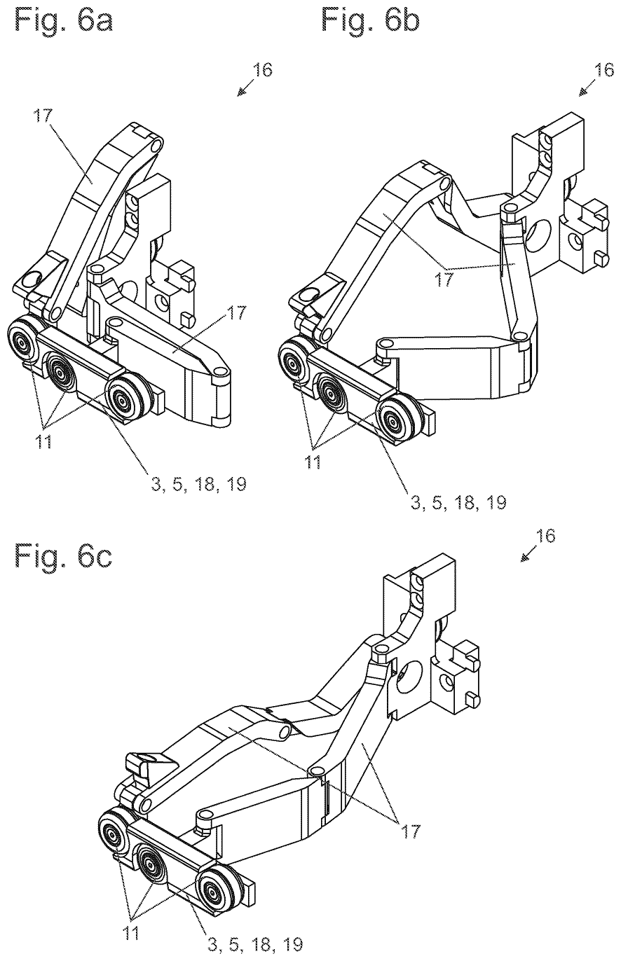

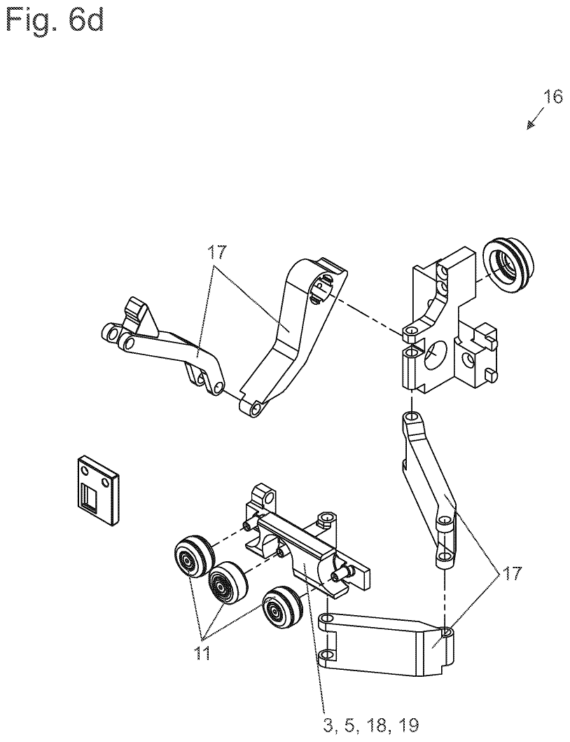

FIG. 6a shows a hinge 16 in the closed position, which hinge can be moved into the intermediate position and the open position in FIG. 6c via the relative arrangement of the two toggle levers 17 in FIG. 6b to be able to move the cover element orthogonally and in parallel relative to the guide system.

The hinge 16 comprises a guide body 3, 5, 18, 19, wherein generally two guide bodies 3, 5 are movable on the guide rails 2, 4 and two guide bodies 18, 19 are movable on the guide rails 13, 14.

FIG. 6d shows an exploded view of the hinge 16, wherein two articulated levers per toggle lever 17 are connected to each other via an articulated connection.

It can also be seen that the guide bodies 3, 5, 18, 19 have three rollers 11. Guide bodies 3, 5, 18, 19 with a different number of rollers 11 are also conceivable.

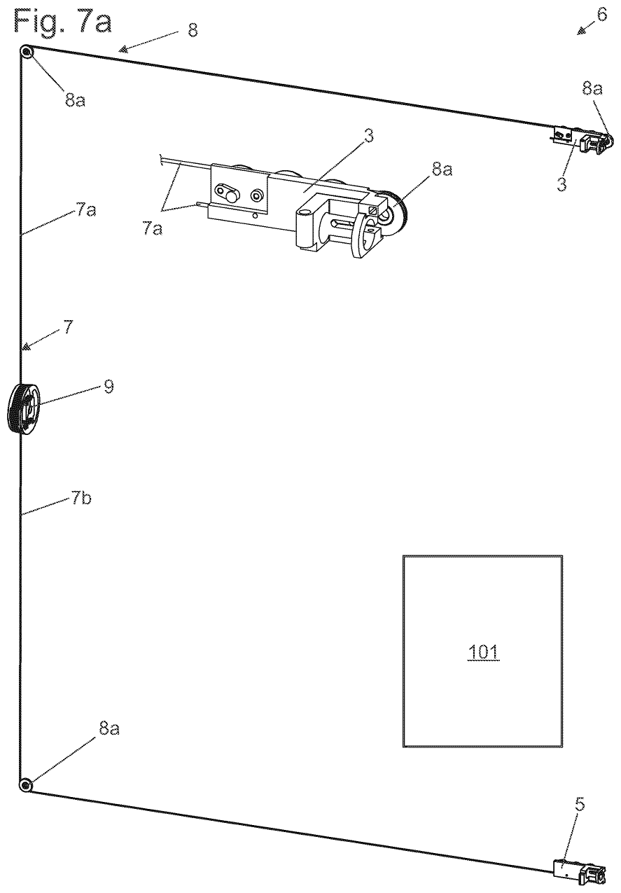

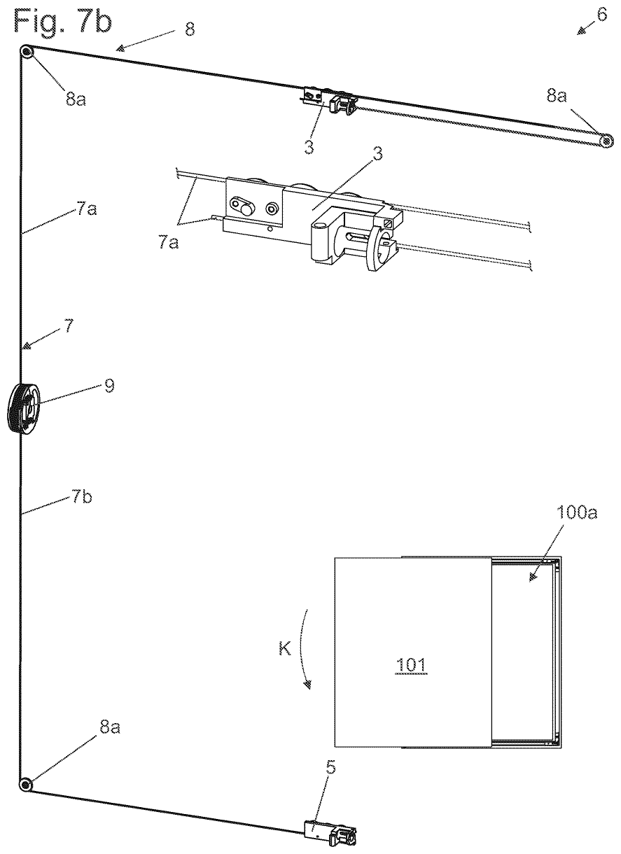

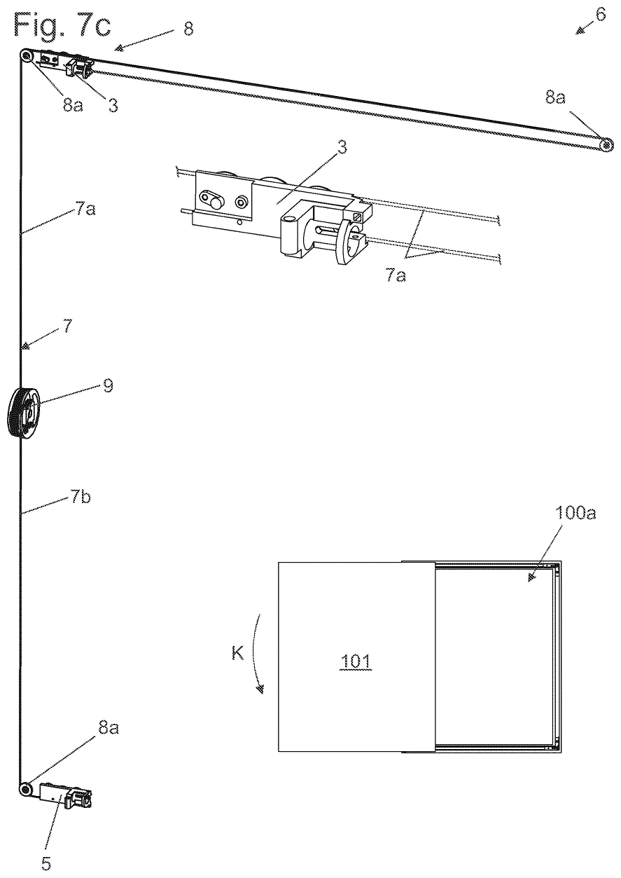

FIG. 7a shows a schematic perspective view of a compensation device 6, a first guide body 3, and a cover element 101 in a closed or intermediate position, FIG. 7b in a half-open position, and FIG. 7c in an open position.

A deflecting device 8 can be seen, which includes three deflection rollers 8a. The cable 7 is deflected via the deflection rollers 8a. The cable 7 is deflected such that an opening 100a which is located in the region delimited by the cable 7 remains free.

In the simplest case, the cable 7 can be a simple, one-piece cable. In the present embodiment, the cable 7 is composed of two partial lengths 7a, 7b. The first partial length 7a is arranged with one end on a shortening mechanism 9. The other end is deflected by 180° via the deflection roller 8a and is arranged on the first guide body 3. The second partial length 7b is arranged with one end on the shortening mechanism 9 and with another end directly on the second guide body 5.

The shortening mechanism 9 thus acts as a connecting device. In the present embodiment, the shortening mechanism 9 is configured as a tapered roller. The shortening mechanism 9 is rotatably mounted on a component block 102.

In the closed or intermediate position (FIG. 7a), the cover element 101 is arranged in front of the opening 100a. If the cover element 101 is moved, the guide bodies 3, 5 move along the guide rails 2, 3. The cable 7 stabilizes the cover element 101. The second partial length 7b is rolled up onto the shortening mechanism 9 and the first partial length 7a is rolled off the shortening mechanism 9.

In FIG. 7b, the cover element 101 is in a half-open position. The cover element 101 has been displaced from the position in FIG. 7a and exposes part of the opening 101a. It can be seen that the guide bodies 3, 5 have been moved along the guide rails 2, 4 (not shown).

The lower partial length 7b of the cable 7 is arranged directly on the carriage 5. When the cover element 101 is moved, the partial length 7b is rolled up onto the shortening mechanism 9, while the upper partial length 7b is rolled off the shortening mechanism 9. The partial length 7a is also deflected onto the guide body 3 via the deflection roller 8a in the upper right corner.

In FIG. 7c, the cover element 101 is in an open position and completely exposes the opening 101a. It can be seen that the guide bodies 3, 5 were moved even further and the partial length 7b was further rolled up onto the shortening mechanism and the partial length 7a was further rolled off the shortening mechanism 9.

A tilting moment K occurring on the cover element 101 can be compensated for via the compensation device 6. The guide body 3 is “held back” by deflecting the upper partial length 7a of the cable 7 onto the guide body 3. This means that forces resulting from the tilting moment K can be absorbed by the cable 7, thereby compensating for the tilting moment K.

Since the tilting moment K also increases with increasing opening of the cover element 101 (due to the larger lever), it is advantageous if the effective length of the cable 7 can be adjusted. This can be achieved via the shortening mechanism 9.

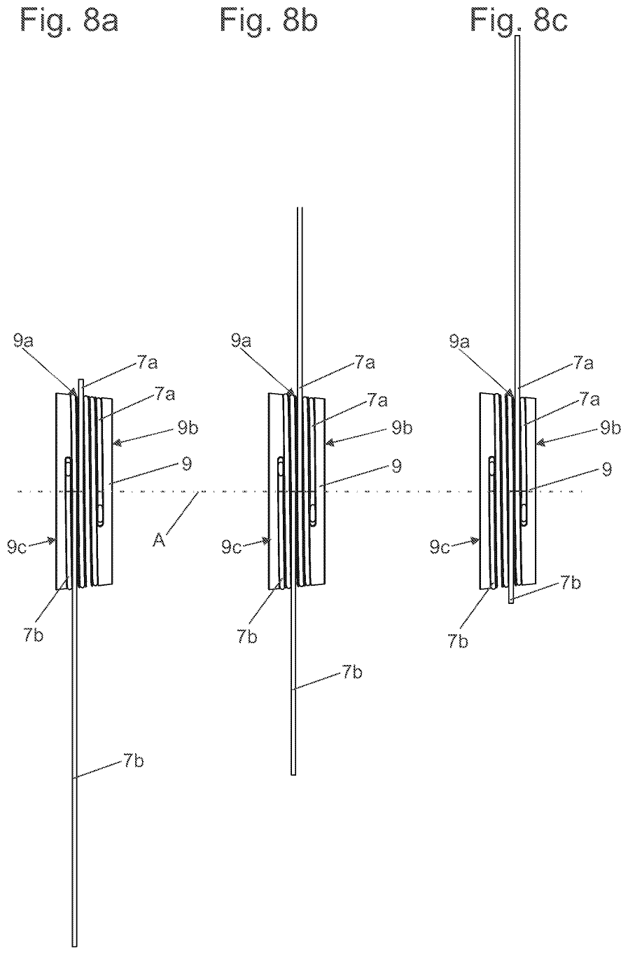

In FIG. 8a, the shortening mechanism 9 is shown in a first position (closed or intermediate position), in FIG. 8b in a partially open position, and in FIG. 8c in a second position (open position).

It can be seen that the cable 7 has two partial lengths 7a, 7b. The partial length 7a is arranged on a side 9b with a smaller diameter on or in the shortening mechanism 9. The partial length 7a is guided in the guide groove 9a, namely for three turns. The partial length 7b, on the other hand, is arranged on a side 9c with a larger diameter on or in the shortening mechanism 9. The partial length 7b is also guided in the guide groove 9a, but only for one turn.

If the cover element 101 is now moved, the guide bodies 3, 5, on which the partial lengths 7a, 7b are arranged accordingly, move as well. As a result, the shortening mechanism 9 rotates about a rotation axis A. As a result, the first partial length 7a is rolled off along the groove 9a and the second partial length 7b is rolled up along the groove 9a. This continues until the cover element 101 is arranged in a second position, in this case: in an open position, or until the movement of the cover element 101 is stopped.

Since the shortening mechanism 9 is designed as a tapered roller, less is rolled off the partial length 7a (since it is arranged on the side 9b with a smaller diameter) than is rolled up from the partial length 7b (since it is arranged on the side 9c with a larger diameter). Due to the tapered roller design, less and less of the partial length 7a is rolled off as the cover element 101 opens. As a result, the upper partial length 7a is shortened in comparison to the lower partial length 7b, whereby the guide body 3 is held back with greater force as the cover element 101 opens more. This means that the increasing tilting moment K can always be compensated accordingly.

In principle, it is also conceivable that the shortening mechanism 9 is configured as a stepped roller or as two or more rotatably connected rollers with different diameters. This also allows the described principle of shortening a partial length 7a to be implemented. However, this does not allow for a continuous change in the compensation of the tilting moment K.

It is also conceivable to design the shortening mechanism 9 as a roller with a special contour, such as a hump, ramp, and a flat part or a step. Other contours are also conceivable. This allows adaptation of the compensation of a tilting moment K to specific conditions.

The partial lengths 7a, 7b of the cable 7 can be arranged on or in the shortening mechanism 9 by known means (for example by clamping). Advantageously, however, the partial lengths 7a, 7b are arranged on the shortening mechanism 9 via a cable tensioning device 10, which is arranged in or on the shortening mechanism 9.

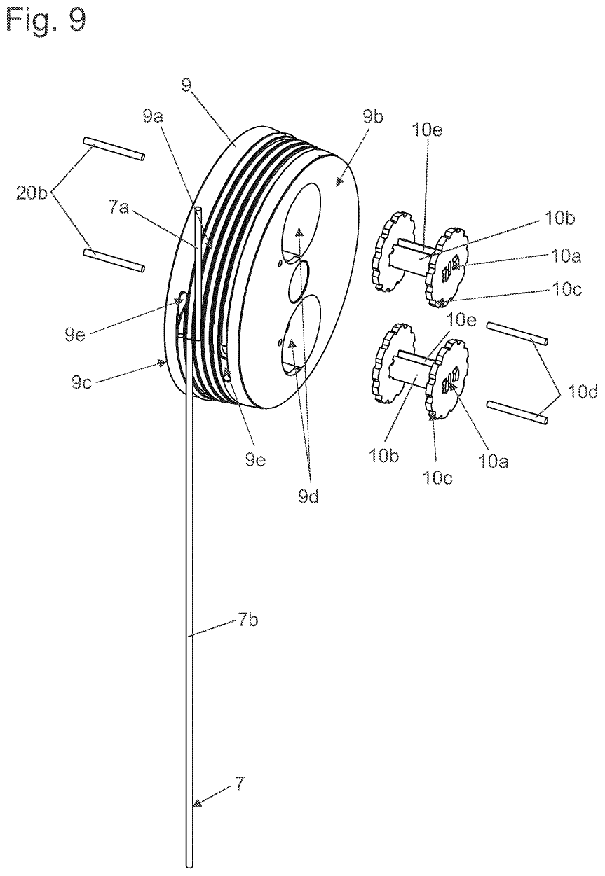

FIG. 9 shows an exploded view of a shortening mechanism 9 with two cable tensioning devices 10. It can be seen that the shortening mechanism 9 has two openings 9d. A cable drum 10b can be inserted into each of these openings 9d. The cable drum 10b is then rotatably and movably mounted in the respective opening 9d. In addition, insertion openings 9e are provided through which the partial lengths 7a, 7b of the cable 7 can be inserted into the shortening mechanism 9 and fed to the cable tensioning devices 10.

The cable drums 10b each have a toothing 10c and a tool holder 10a for actuating the cable tensioning devices 10. A locking mechanism 20a can be formed via locking pins 10d in cooperation with the toothing 10c. In addition, locking pins 20b are provided for additional securing of the cable tensioning device 10. The locking mechanism 20a and a locking pin 20b each form a locking device 20. It is also conceivable that only one locking mechanism 20a or only one locking pin 20b is provided.

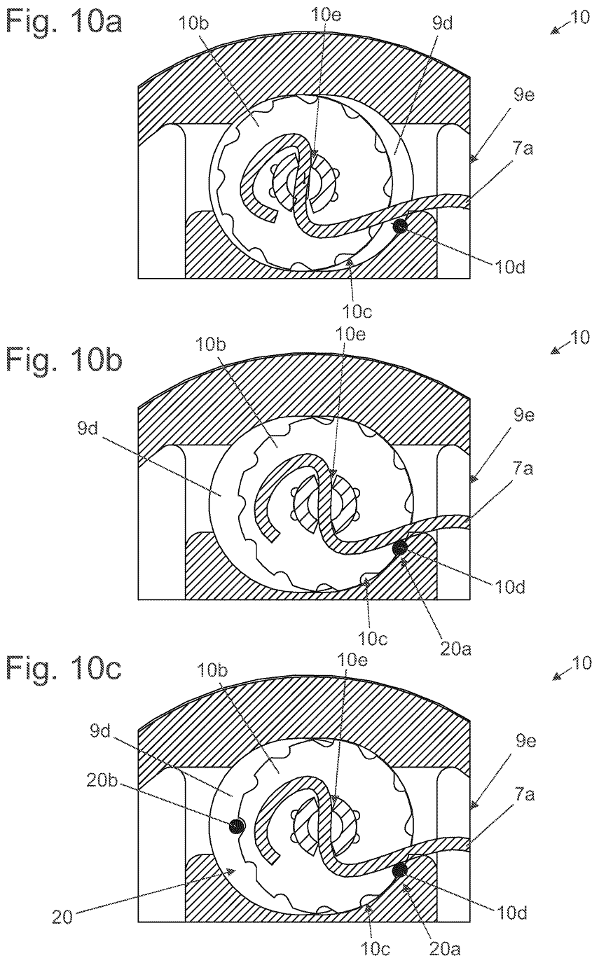

FIGS. 10a to 10b show steps for tensioning a cable 7, in this case the partial length 7a. For the partial length 7b, tensioning is carried out analogously.

It can be seen that the partial length 7a is inserted into the shortening mechanism 9 and into a slot 10f in the cable drum 10a. The cable drum 10b is mounted in the opening 9d. The opening 9d is designed in the shape of an elongated hole, whereby the cable drum 10b is not only rotatable but also movable. In addition, a locking pin 10d is visible.

If the cable tensioning device 10 is actuated (i.e., the cable drum 10b is rotated), the partial length 7a is at least partially wound onto the cable drum 10b (not shown here). This tensions the cable 7 and moves the cable drum 10a in the direction of the locking pin 10d. The locking mechanism 20a is now formed via the toothing 10c and the locking pin 10d. This allows further rotation of the cable drum 10b (i.e., tensioning of the partial length 7a), but maintains the cable tension when the cable tensioning device 10 is no longer actuated (FIG. 10b).

In the event that there is no tension on the cable 7 (partial length 7a) in a position of the guide system 1, an additional safety pin 20b is inserted. This locking pin 20b engages with the toothing 10c and prevents the cable drum 10b from moving into an initial position as shown in FIG. 10a. The cable tensioning device 10 is thus locked.

### LIST OF REFERENCE NUMERALS

1 guide system
2 first guide rail
3 first guide body
4 second guide rail
5 second guide body
6 compensation device
7 cable
7a partial length
7b partial length
8 deflecting device
8a deflection roller
9 shortening mechanism
9a helical groove
9b first side
9c second side
9d opening
9e insertion opening
10 cable tensioning device
10a tool holder
10b cable drum
10c toothing
10d locking pin
10e slot
11 rollers
12 drive device
13 additional guide rail
14 additional guide rail
15 synchronization rod
16 hinge
17 toggle lever
18 additional guide body
19 additional guide body
20 locking device
20a locking mechanism
20b locking pin
100 stationary structure
100a opening
100b frame
101 cover element
101a frame
102 component block
A pivot axis
K tilting moment
L longitudinal extension

1. A guide system for movably supporting at least one cover element for covering an opening in a stationary structure, the guide system comprising:
a first guide rail and a first guide body movably arranged thereon,
a second guide rail and a second guide body movably arranged thereon, and
a compensation device for compensating for a tilting moment of a cover element,
wherein the cover element can be moved by the guide system between a first position, preferably a closed or intermediate position, and a second position, preferably an open position,
wherein the compensation device has at least one cable, the at least one cable connecting the first guide body and the second guide body together, and in that a deflecting device is provided, by which the at least one cable can be guided orthogonally to the longitudinal extension of the first guide rail and/or the second guide rail at least in some regions, preferably in a region between the first guide rail and the second guide rail.

2. The guide system of claim 1, wherein the deflecting device comprises at least three, preferably exactly three, deflection rollers.

3. The guide system of claim 2, wherein two of the at least three deflection rollers are arranged on or in the region of the first guide rail and another one of the at least three deflection rollers is arranged on or in the region of the second guide rail.

4. The guide system of claim 1, wherein at least one shortening mechanism is provided, via which a length of the at least one cable can be adjusted between a first and a second position depending on a position of the cover element.

5. The guide system of claim 4, wherein the shortening mechanism is configured in the form of a tapered roller.

6. The guide system of claim 4, wherein the shortening mechanism has at least one guide groove in which the at least one cable is guided.

7. The guide system of claim 5, wherein the at least one guide groove extends helically along a tapered portion of the tapered roller.

8. The guide system of claim 1, wherein at least one cable tensioning device, preferably at least two cable tensioning devices, is/are provided for tensioning the at least one cable.

9. The guide system of claim 8, wherein the at least one cable tensioning device has a tool holder, preferably in the form of a screw head drive, for actuating the cable tensioning device.

10. The guide system of claim 4, wherein the at least one cable tensioning device is arranged, preferably rotatably and/or movably, on or in the shortening mechanism.

11. The guide system of claim 8, wherein the cable tensioning device has a cable drum onto or off which the at least one cable can be wound.

12. The guide system of claim 8, wherein the cable tensioning device has a locking device for locking the cable tensioning device.

13. The guide system of claim 12, wherein the locking device comprises a locking mechanism and/or a locking pin.

14. The guide system of claim 1, wherein the at least one cable is formed from at least two partial lengths.

15. The guide system of claim 13, wherein at least one connecting device is configured to connect the at least two partial lengths of the at least one cable, preferably wherein the connecting device is formed by the shortening mechanism and/or the at least one cable tensioning device.

16. The guide system of claim 5, wherein one of the at least two partial lengths can be rolled up onto the tapered roller during a movement of the cover element between a first and a second position, and the other of the at least two partial lengths can be rolled off the tapered roller.

17. An arrangement comprising:
a stationary structure having at least one opening formed therein,
at least one cover element, and
the guide system of claim 1,
wherein the cover element is movable by the guide system between a first position, preferably a closed or intermediate position, and a second position, preferably an open position.

18. The arrangement of claim 17, wherein the cover element is substantially quadrangular, the guide system has four hinges which are arranged in the first position in the region of the four corners of the cover element, preferably wherein two hinges are arranged vertically spaced apart from one another on the stationary structure and two hinges are arranged vertically spaced apart from one another on the cover element and are connected to the cover element in a motion-coupled manner.

19. The arrangement of claim 17, wherein the at least one cable is arranged substantially, preferably completely, outside a region of the opening.
